(19) United States
(12) Patent Application Publication
(10) Pub. No.: US 2018/0226908 A1
(43) Pub. Date: Aug. 9, 2018

(54) METHOD AND SYSTEM FOR ADJUSTING WIND TURBINE POWER TAKE-OFF

(71) Applicant: OBSHCHESTVO S OGRANICHENNOJ OTVETSTVENNOSTYU "VDM-TEKHNIKA", Moscow (RU)

(72) Inventors: Vladimir Gennadevich MASOLOV, Moscow (RU); Valerij Sergeevich BEREZIN, St. Petersburg (RU); Anatolij Leonidovich LOGINOV, St. Petersburg (RU); Ivan Georgievich POLETAEV, St. Petersburg (RU); Andrej Gennadevich MASOLOV, Moscow (RU); Ivan Aleksandrovich FADEEV, St. Petersburg (RU); Andrej Viktorovich KHUDONOGOV, Moscow (RU)

(21) Appl. No.: 15/944,896

(22) Filed: Apr. 4, 2018

Related U.S. Application Data
(63) Continuation of application No. PCT/RU2016/000868, filed on Dec. 13, 2016.

(51) Int. Cl. H02P 9/06; F03D 7/02; F03D 7/04; F03D 9/25; H02P 9/00; H02P 9/10

(52) U.S. Cl. CPC H02P 9/06; F03D 7/0272; F03D 7/0264; F03D 7/044; H02P 2101/15; H02P 9/009; H02P 9/105; H02P 9/107; F03D 9/25

(57) ABSTRACT

A method and a system for adjusting a wind-turbine power take-off. The system comprises: a plurality of phase current sensors and a plurality of voltage sensors operatively connected to a synchronous electric generator, an active rectifier, and a micro-controller. Instructions stored on the micro-controller, when executed, are configured to cause the micro-controller to execute the method comprising: obtaining a measurement of generator's output phase voltages; determining rotor rotation angle based on the measured generator's output phase voltages; executing an optimization algorithm to determine an optimized speed of the synchronous electric generator based on a target energy value. The synchronous electric generator is controlled based on the determined optimized speed by at least one of: setting an electromagnetic torque on a shaft of the synchronous electric generator, setting currents in windings of the synchronous electric generator, and controlling the active rectifier boost converter function operating in conjunction with a down converter.

### CROSS-REFERENCE

The present application is a continuation of International Patent Application no. PCT/RU2016/000868, filed on Dec. 13, 2016 entitled “METHOD OF ADJUSTING WIND TURBINE POWER TAKE-OFF”. This application is incorporated by reference herein in its entirety.

### FIELD OF THE TECHNOLOGY

Non-limiting embodiments of the present technology relate to the field of wind power and may be used for creating and modifying wind energy installations such as to operate more efficiently.

### BACKGROUND

U.S. Pat. No. 4,525,633 describes the method and apparatus for controlling the level of power transferred through a stand-alone wind power generating system. The key-point of the method is calculation of the output to the optimum ratio of rotation speed and wind speed with the usage of a wind speed sensor and wind power conversion system. The disadvantage of such method is the need to use a wind speed sensor, which either is not accurate enough, or has a high cost and at the same time is an additional source of possible dysfunctions.

U.S. Pat. No. 4,695,736 describes the method for controlling of wind energy installations and a wind turbine structure implementing that method. The method is based on torque control according to the schedule defining generator speed relative to the measured generated power, in order to increase efficiency of wind turbine. Thus, if the optimum speed lies below the actual speed, the frequency corresponding to the power will be lower than the actual one and a current reference (torque) will be generated in the direction of the reduction of the rotational speed. At an optimum frequency higher than the actual one, the power will correspond to a higher frequency of rotation, and the wind turbine will accelerate. The disadvantage of this method is the need to use a predefined schedule, a priori different from the actual performance of the wind installation.

U.S. Pat. No. 8,242,620 describes the structure of a wind turbine providing for the use of an active rectifier with the ability to control the rotational velocity within a predetermined range by generating a current task. This allows to stabilize the rotational velocity and to ensure the efficient operation of wind turbines at certain wind speeds corresponding to the speed of the wind turbine. The disadvantage of the prototype is the low efficiency of operation of the wind turbine in a wide range of wind speeds.

### SUMMARY OF THE TECHNOLOGY

The objective of the present technology is to increase the efficiency of the operation of wind turbines in a wide range of wind speeds, including the low values of the average annual wind speeds (3-6 m/s).

The technical result of the present technology is in increasing the wind power conversion coefficient in the entire range of operating speeds of the wind turbine.

In accordance with one aspect of the present technology, there is provided a method of adjusting a wind-turbine power take-off. The method is executable in a system including: a wind turbine; a synchronous electric generator operatively coupled to the wind turbine; an active rectifier and a down converter for controlling voltage and current settings of the synchronous electric generator; and a micro-controller configured to control operation of at least one of the synchronous electric generator, the active rectifier and the down converter, the micro-controller storing computer executable instructions. The instructions, when executed, are configured to cause the micro-controller to execute the method comprising: obtaining a measurement of generator's output phase voltages; determining rotor rotation angle based on the measured generator's output phase voltages; receiving a target energy value including one of a target consumer voltage and a target consumer current; execute an optimization algorithm to determine an optimized speed of the synchronous electric generator based on the target energy value; and controlling the synchronous electric generator based on the optimized speed of the synchronous electric generator, the controlling being executed by at least one of: setting an electromagnetic torque T_{E} on a shaft of the synchronous electric generator, proportional to a linear value of a current value of the synchronous electric generator, determined by the phase currents i_{A}, i_{B}, i_{C} generated by the active rectifier; setting currents i_{A}, i_{B}, i_{C} in windings of the synchronous electric generator, the currents being in a sinusoidal form; and controlling the active rectifier boost converter function operating in conjunction with the down converter.

In at least one embodiment, the setting the electromagnetic torque T_{E} on a shaft of the synchronous electric generator further comprises transmitting, by the microcontroller, pulse-width modulated signals to at least one of the active rectifier and the down converter.

In at least one embodiment, the method may further comprise reducing the consumer voltage by controlling the down converter.

In at least one embodiment, the method may further comprise measuring an actual consumer current and, based on the actual consumer current, generating and transmitting at least one of a second pulse-width modulated signal to a ballast and a third pulse-width modulated signal to the down converter, in order to adjust the consumer current.

In at least one embodiment, the method may further comprise: in response to the wind speed being higher than the calculated wind speed, setting the electromagnetic torque T_{E} on a shaft of the synchronous electric generator that exceeds the torque T_{R} of the shaft of the synchronous electric generator to reduce the speed of the wind turbine.

In at least one embodiment, the method may further comprise: in response to determining that a voltage on a capacitor, located between the active rectifier and the down converter, exceeds a threshold capacitor voltage, generating and transmitting a second pulse-width modulated signal to the ballast; and adjusting a current between the active rectifier and the down converter. In at least one embodiment, the method may further comprise: generating and transmitting a breaking signal S1 to a breaking system to cause a stepped stop of the synchronous electric generator in response to the output voltage of the active rectifier exceeding a threshold voltage.

In at least one embodiment, the optimization algorithm to determine an optimized speed of the synchronous electric generator based on the target energy value may comprise: based on the measured phase currents generated by a synchronous electrical generator, estimating change in an output energy of the synchronous electric generator during a time interval; based on the change in the output energy and a corresponding change in the rotation speed during the time interval, determining an optimized speed of the synchronous electric generator.

In at least one embodiment, the rotor rotation angle may be determined based on the phase currents measured by current sensors located between the synchronous electric generator and the active rectifier.

In accordance with another aspect of the present technology, there is provided a system for adjusting wind turbine power take-off, the wind turbine being operatively coupled to a synchronous electric generator. In at least one embodiment, the system comprises: a plurality of phase current sensors operatively connected to the synchronous electric generator, the phase current sensors being configured to determine phase currents at the output of the synchronous electric generator; a plurality of voltage sensors operatively connected to the synchronous electric generator and configured to determine phase voltages at the output of the generator; an active rectifier being configured to generate an electromagnetic torque by forming sinusoidal in-phase currents in the phase windings of the synchronous electric generator; and a microprocessor, operatively connected to the synchronous electric generator, the active rectifier and a down converter being configured to control operation of at least one of the synchronous electric generator, the active rectifier and the down converter, based on the phase currents and the rotor rotation angle determined from the phase voltages.

In at least one embodiment, the system may further comprise a breaking system operatively connected to the windings of the synchronous electric generator and configured to produce a stepped breaking of the synchronous electric generator or an emergency stop of the wind turbine in response to a breaking signal received from the microprocessor.

In at least one embodiment, the system may further comprise a ballast with pulse-width modulated switching, the ballast being configured, under control of the microcontroller, to divert electric power in response to the voltage at the output of the active rectifier exceeding a predetermined value.

In at least one embodiment, the down converter may be configured to maintain voltage in a DC link between the active rectifier and the down converter within a predetermined range and to reduce voltage at the output of the power take-off system to match the target consumer voltage.

In at least one embodiment, the system may further comprise current sensors located at the input and output of the down converter, the current sensors configured to transmit the measured current to the microprocessor.

In at least one embodiment, the synchronous electric generator may be a disk structure with permanent magnets with axial magnetization, the rotor comprising two coaxial discs arranged on both sides of the stator and rigidly interconnected. In at least one embodiment, the system may further comprise a power supply unit for electronic devices connected directly to the output of the synchronous electric generator.

In accordance with another aspect of the present technology, a method of adjusting wind turbine power take-off is based on controlling a speed of a wind turbine in accordance with an optimum speed search algorithm that estimates a change in an output energy for a given time interval as the rotational speed changes and sets a new speed value based on the values obtained; at the wind speed above a calculated wind speed, which corresponds to the nominal value of power, ensuring stabilization of the electromagnetic torque on the synchronous winding shaft, at the same time the control of the speed of rotation in the entire range of working wind speeds is carried out by a power take-off system consisting of: a synchronous generator with permanent magnets with a rotor position sensor mounted on a single shaft with a wind turbine; a power supply unit for electronic devices connected directly to the output of an electrical machine; an active rectifier with phase current sensors CS_{A}, CS_{B}, CS_{C}, phase voltage sensors VS_{A}, VS_{B}, connected at the input, and a voltage sensor VS, a capacitor C₀, a current sensor CS1, all three connected at the output, while the active rectifier is made with a vector control, implemented by a microprocessor programmable controller, providing the possibility of specifying the electromagnetic torque by forming sinusoidal, in-phase with EMF, currents of a given amplitude in the phase windings of the generator and converting them at the output of the active rectifier to the charging current of the DC link capacitor with a voltage higher than the consumer specified output voltage, this stabilization of the voltage in a predetermined range of values is provided by a down converter under control of the microprocessor controller at full power take-off by the consumer, and, if the full power take-off is impossible by consumer, the stabilization of the voltage is provided by a down converter and a ballast controlled by the microprocessor controller; the down converter, being controlled by the microprocessor controller, the down converter being configured to maintain voltage in a DC link between the active rectifier and the down converter within a predetermined range of values, as well as to lower the output voltage to the desired level of consumer and to limit a maximum current value for a short circuit protection; a ballast for removal of excess electricity under control of a microprocessor controller; a braking system associated with the windings of the synchronous electric generator, which, under the control of the microprocessor controller, produces a stepped braking of the synchronous electric generator or an emergency stop of the wind turbine, at the moment when the vector control is turned on and the generator rotates at no-load speed according to the voltage sensors VS_{A} and VS_{B}, the phase voltage values U_{A} and U_{B} are determined, which are fed to the rotor rotation angle calculation block, the angle value is fed to the integrator and is set as the initial value of the rotor rotation angle, based on which transformations in blocks are produced, with the actual value of the rotor rotation angle different from the initial one, there is a mismatch in the current d-component, at the output of the PI-controller the value other than zero is obtained, which is supplied to an integrator, changes the value of the angle, implements dynamic determination of the actual rotor rotation angle, the position of the EMF vector is determined and the compensation for the current d-component is introduced.

In at least one embodiment, the power take-off system further comprises a ballast with pulse-width modulated switching.

In at least one embodiment, the synchronous electric generator is a disk structure with permanent magnets with axial magnetization, the rotor consisting of two coaxial discs arranged on both sides of the stator and rigidly interconnected.

The technical result of the technology may be achieved due to the fact that the method of controlling the power take-off from the wind turbine, including the control over the speed of the wind turbine in the entire range of operating wind speeds, in accordance with the algorithm for finding the optimum speed, which estimates the change in the energy produced in a given time interval with a change in the rotational speed and sets a new value of the rotation speed on the basis of the values obtained, and at a wind speed higher than the calculated one, which ensures the stabilization of the electromagnetic torque on the shaft of the synchronous electric generator, while the speed control in the entire range of working wind speeds is performed by a power take-off (PTO) system consisting of a synchronous electric generator with permanent magnets with a rotor position sensor mounted on one shaft with the wind turbine; own power supply unit for electronic devices connected directly to the output of an electrical machine; active rectifier with vector control by the microprocessor programmable controller, providing the possibility of specifying the electromagnetic torque by forming sinusoidal in-phase with EMF currents of a given amplitude in the phase windings of the generator and converting them at the output of the active rectifier to the charging current of the DC link capacitor with a voltage higher than the user specified output voltage, this stabilization of the voltage in a predetermined range of values is provided by a down converter under the control of the microprocessor controller, with full selection of the output power by the consumer, and in the event of impossibility of full power take-off by the consumer it is ensured by the combined operation of the down converter and the ballast under the control of the microprocessor controller; operating under the control of a microprocessor controller of a down converter that maintains the voltage in the DC link between the active rectifier and the down converter in a given range of values, as well as reducing the output voltage to the level required by the consumer and limiting the maximum current to protect against short circuit; ballast for the removal of excess electricity under the control of a microprocessor controller; the braking system associated with the windings of the synchronous electric generator, which, under the control of the microprocessor controller, produces a stepped braking of the synchronous electric generator or an emergency stop of the wind turbine.

In some implementations of the present technology, a ballast with PWM switching is provided, this allows smoothly adjusting the power removed by the B and reducing the capacitor voltage to an acceptable level without interrupting the operation of the DC and transferring power to the consumer.

In some implementations of the present technology, the synchronous electric generator has a disk structure with permanent magnets with axial magnetization consisting of a rotor with two coaxial disks located on both sides of the stator and rigidly connected to each other, the volume of the toroidal stator, reduce the reaction of the armature and the path of the magnetic flux, thereby reducing the specific losses, as well as increasing the operational efficiency of the synchronous electric generator, simplify the docking with the wind turbine, while the usage of the slotless annular magnetic core of the stator makes reduction of the torque of static resistance of the synchronous electric generator and reduction of the torque of the winding of the wind turbine possible.

Usage of an adjustable wind turbine power take-off system consisting of a synchronous electric generator on permanent magnets with a rotor position sensor, an active rectifier with a microprocessor controller, a power supply unit, a braking system, a ballast and a down converter. For this structure, a control method may be implemented, it may ensure an increase of the wind power conversion coefficient over the entire operating speed range and stabilize the electromagnetic torque on the generator shaft at a wind speed higher than the design value corresponding to the nominal value of the power. The control method is based on the control of the speed of the wind turbine in accordance with the optimal speed search algorithm, which estimates the change in the generated energy at a given time interval and sets a new value of the frequency of rotation.

### BRIEF DESCRIPTION OF THE DRAWINGS

The details, features, and advantages of the present technology result from the following description of embodiments of the claimed system and method for controlling the power take-off of a wind turbine using the drawings where:

FIG. 1 depicts a block diagram of general structure of a wind energy installation, in accordance with non-limiting embodiments of the present technology.

FIG. 2 depicts a block diagram of a structure of the power take-off system, in accordance with non-limiting embodiments of the present technology.

FIG. 3 depicts a block diagram of a flow chart of a method for finding the optimum speed of the wind turbine, in accordance with non-limiting embodiments of the present technology.

FIG. 4 depicts a block diagram of operation of a rotation frequency regulator, in accordance with non-limiting embodiments of the present technology.

FIG. 5 depicts a block diagram of operation of active rectifier control, in accordance with non-limiting embodiments of the present technology.

### DESCRIPTION OF THE NON-LIMITING EMBODIMENTS

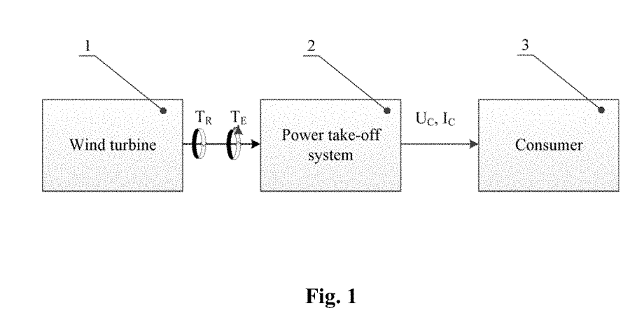

Referring now to FIGS. 1-5, where the following reference numbers are used: 1—wind turbine; 2—power take-off system; 3—the consumer of generated electric power; 4—synchronous electric generator; 5—power supply; 6—microprocessor controller; 7—braking system; 8—active rectifier; 9—ballast; 10—down converter; 11-19 indicate steps of the method of operation of the wind turbine power take-off control system; 20-22—steps performed by the functional circuit of the speed controller; 23-29—steps performed by of the functional control circuit of the active rectifier.

FIG. 1 depicts a block diagram of a general structure of a wind energy installation, in accordance with non-limiting embodiments of the present technology. The wind energy installation comprises a wind turbine (1), attached to the power take-off (PTO) control system (2) transmitting to the consumer (3) the generated electric power.

Wind turbine (1) generates torque T_{R} on the shaft in accordance with its characteristics and characteristics of the wind flow. The power take-off system of the wind turbine (2) generates an electromagnetic torque T_{E} on the shaft. The power take-off of the wind turbine (2) converts the mechanical energy of the wind turbine (1) into electric energy required for the consumer (3) voltage U_{C} and the set current I_{C}. For example, a battery of a specified voltage or a network inverter may be considered as a consumer (3).

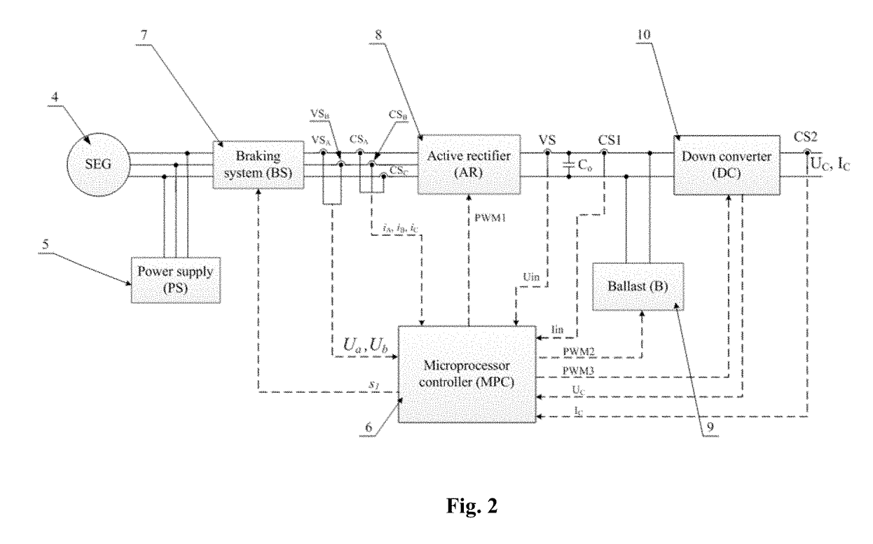

FIG. 2 depicts a block diagram of PTO system of the wind turbine (WT), in accordance with non-limiting embodiments of the present technology. The PTO system of the wind turbine (WT) has a synchronous electrical generator (SEG) (4), mounted on the same shaft with the WT, with the connected power supply (PS) (5) at the output of the SEG. The microprocessor controller (MPC) (6) controls the operation of the braking system (BS) (7) connected to the windings of the SEG; the operation of the active rectifier (AR) (8) with connected phase current sensors CS_{A}, CS_{B}, CS_{C} at the input and connected voltage sensor VS at the output, the capacitor C₀, current sensor CS1; the operation of the ballast (B) (9) and the down converter (DC) (10) with the current sensor CS2 at the output.

PTO turbine system includes power, measuring and control devices whose primary purpose is to control the turbine speed in accordance with a method of determining of optimum rotational frequency, which estimates the change of energy output and produces the new reference speed value.

The solution of the problem of increasing the wind power conversion factor for a wide range of wind speeds may be provided by the following:
Setting the electromagnetic torque T_{E} on the shaft of the synchronous electric generator, proportional to the linear value of the current value of the synchronous electric generator, determined by the phase currents i_{A}, i_{B}, i_{C} formed by an active rectifier with vector control from a microprocessor-based programmable controller in accordance with the developed algorithms;
Setting the currents i_{A}, i_{B}, i_{C} in the windings of the synchronous electric generator, the currents having sinusoidal form, coinciding in phase with the EMF of the generator, without additional harmonic components, thereby increasing the efficiency in the entire range of operating rotation frequencies;
Implementing a function of boost converter by the active rectifier, the boost converter operating in conjunction with the down converter, providing a voltage value Uᵢₙ, greater than U_{C}, and required values of U_{C} and I_{C} Thus, it becomes possible to use a synchronous electric generator with a high efficiency value.

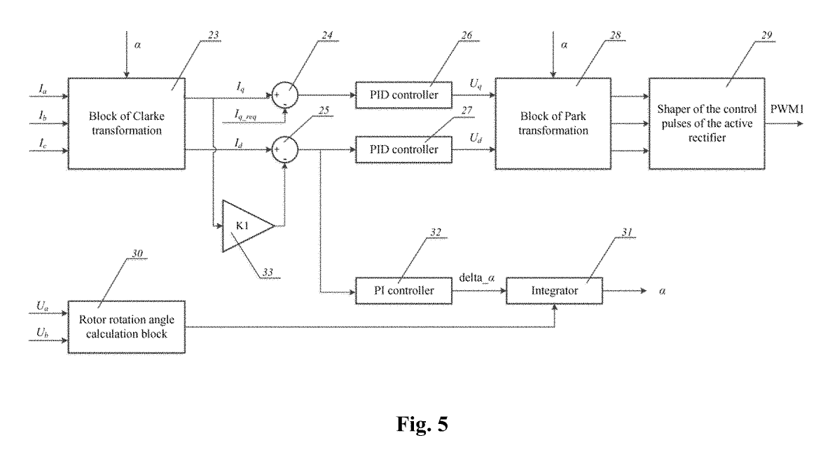

The microprocessor-based programmable controller realizes the vector control of the active rectifier by forming PWM1 pulse-width modulated (PWM) signals in accordance with the value of the angle α of rotation of the rotor of the synchronous electric generator. The value of rotor angle α is determined by the rotor rotation angle calculation block (30), depicted at FIG. 5.

The usage of the sensorless vector control allows to get rid of the rotor position sensor and of the communication line with the MPC, this makes construction of the WT easier.

Feedback on the current loop is organized with the usage of the current sensors CS_{A}, CS_{B}, CS_{C}.

A power supply connected directly to the output of a synchronous electric generator provides low-voltage power to electronic devices.

Braking system produces a stepped stop synchronous electric generator by microprocessor programmable controller command when the voltage exceeds the threshold value Uᵢₙ or the wind turbine emergency stop in case of failure of one of the devices of the PTO system of the WT.

The down converter maintains the voltage of the DC link on the capacitor C₀ between an active rectifier and the down converter in the predetermined range of values of Uᵢₙ according to the readings of the voltage sensor VS due to the current Iᵢₙ regulation according to the readings of the current sensor CS1 and the current I_{C} regulation according to the readings of the current sensor CS2 by the signals PWM3 and PWM2 of the microprocessor-based programmable controller. The down converter reduces the voltage to the desired level U_{C} and allows limiting the maximum value of current I_{C}, this ensures protection from the short circuit.

The ballast (B) with a capacity of at least the nominal power of the synchronous electrical generator, under the control of a programmable microprocessor controller diverts excess electric power in case of exceeding the predetermined value of Uᵢₙ.

The method of control of the wind turbine power take-off as described herein may provide an increase of the wind power conversion coefficient in the entire range of operating speeds of the wind turbine and may stabilize the electromagnetic torque on the generator shaft at a wind speed higher than the rated speed corresponding to the nominal value of the power. The method of control of the wind turbine power take-off is based on controlling the speed of the wind turbine in accordance with the optimum speed search algorithm, which estimates the change in the generated energy at a given time interval and sets a new value of the speed.

The power take-off system may implement three following operating modes:

1. The first operating mode may be in the range of wind speed from minimum working to rated, at which the SEG generates the rated power.

In the turbine speed range from the minimum operating to nominal PWM signals PWM1 to AR with the MPC, switching of the SEG windings is performed. In this case, sinusoidal in-phase with EMF currents of a given amplitude are formed in the phases of the generator i_{A}, i_{B}, i_{C}, which may ensure minimization of losses in the windings of the SEG and the formation of the optimum speed of rotation on the shaft of the SEG in accordance with the method as described herein. Synphase and sinusoidal currents are provided by vector control according to the RPS readings. The active rectifier converts the EMF of the SEG and converts the variable phase currents i_{A}, i_{B}, i_{C} to the constant output current Iᵢₙ with the Uᵢₙ voltage on the capacitor C₀.

At full power take-off by the consumer, stabilization of the voltage Uᵢₙ at the capacitor C₀ in a predetermined range of values is provided by DC due to adjusting of the current I_{C}, according to indications CS2, by modulated PWM signal PWM3 from MPC.

When the complete PTO for the consumer is impossible (I_{C} is limited by the consumer), the stabilization of the voltage Uᵢₙ on the capacitor C₀ in a given range of values is ensured by the joint operation of the DC and B. Control of the current I_{C} according to CS2 readings is performed by modulated PWM signals PWM3 and PWM2 from MPC with connecting the ballast B.

2. The second operating mode may be in the range of wind speed values that exceed the calculated value.

If the value of the wind speed exceeds the calculated value of the wind speed of the wind turbine, the wind turbine creates torque on the shaft T_{R} excess of the nominal value of the electromagnetic torque T_{E} of the synchronous electric generator. The frequency of rotation of the SEG becomes higher than the nominal one and the AR starts to work in the diode bridge mode. In this case, the amount of electric power supplied from the output of the AR exceeds the rated value and DC are not able to stabilize the voltage Uᵢₙ the capacitor C₀. Upon reaching the capacitor threshold voltage Uᵢₙ the MPC generates PWM signal PWM2, which connects the ballast and according to the indications of the CS1 multiple unit generates a current I_{c} at the output of AR thus generating a nominal electromagnetic torque T_{E}. If the generated torque T_{E} exceeds T_{R} acting on the shaft of the SEG and WT, the speed is reduced and the wind turbine enters the operation mode 1.

If the generated torque T_{E} is insufficient for braking SEG, SEG rotation speed increases, the EMF of the SEG increases and, according to the indications of the VS, the MPC transmits the signal s1 to the BS, after which the BS performs the stepwise braking of the SEG and WT. During the operation of the BS, formation of the AR currents and the charging of the capacitor C₀, the DC continues to generate power, which leads to decrease of the voltage Uᵢ on the VS below the set value. After the BS triggering, the windings of the synchronous generator remain short-circuited until the voltage drops below the set value, after which the wind turbine goes into operation mode 2 with a ballast.

3. The third operating mode may be emergency operation of wind turbines in case of failure of one of the devices from the PTO system of the WT. In this case, the BS stops the wind turbine.

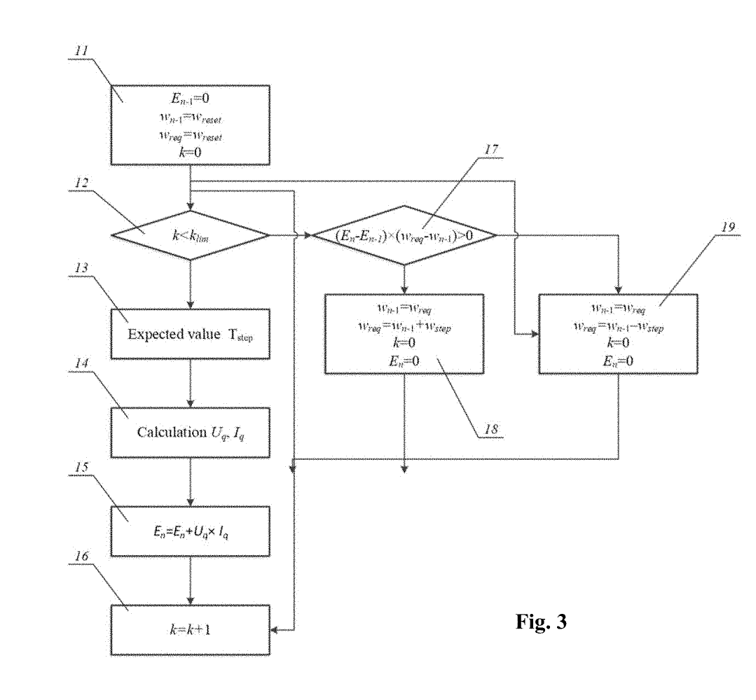

FIG. 3 depicts the block diagram of a flowchart of a method of searching the optimum frequency of turbine's rotation, in accordance with non-limiting embodiments of the present technology. The method is based on the search for the optimum speed of rotation based on change in the average value of the generated energy for a given time interval.

At step (11), the initial parameters are specified: Eₙ—the total “energy” obtained at the previous iteration of the cycle, wₙ₋₁—the specified speed at the previous iteration of the cycle, w_{req}—the specified rotational speed at this iteration of the cycle, k—the number of cycle passes. At step (12), the number of passes with a given limit value is compared. At step (13), the time delay for the cycle is specified. At step (14), the values of q components for voltage Uq and current Iq are generated.

At step (15), value at this iteration of the loop is added to the value of the total “energy” Eₙ. The concept of “energy” in this case may be applied with a reservation, since instantaneous power values are summed up for amplitude values of current and voltage of one phase and the total value is not equal to the actual generated energy of the generator, but always proportional to it with the same coefficient. Thus, the obtained values of “energy” may be correctly compared with each other, as implemented in this method.

At step (16), the pass counter is increased and when the limit value is reached, the step (17) is executed, comparing the product of the change in “energy” and the rotation frequency between the past and the current iteration with zero. A value greater than zero means either that the speed has been increased and the value of “energy” has been increased, or that the speed has decreased and the value of “energy” has also decreased, that is why, it may be required to increase the speed that is performed at step (18). A value less than zero means that the rotation speed has decreased and the energy value has been increased or the rotation speed has been increased and the energy value has decreased, therefore, it is required to reduce the speed of the wind turbine that is performed at step (19).

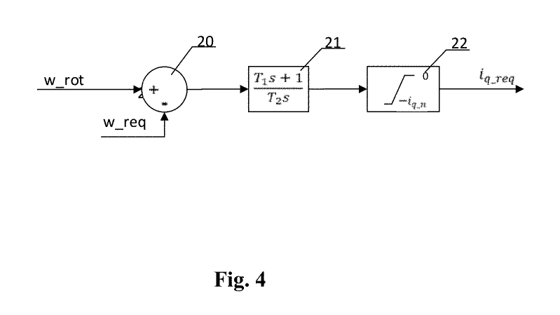

FIG. 4 depicts a block diagram of operation of the speed controller, in accordance with non-limiting embodiments of the present technology. The vector control scheme is implemented. The adder (20) calculates the difference between the set speed value w_{req} and the actual wᵣₒₜ, the difference value is fed to the PI regulator (21). The block (22) provides the limitation of setting of the current I_{q}_{_}_{req} in the range from zero to the nominal value of the electric machine in order to avoid its transfer to the motor mode and not to exceed the permissible current value.

FIG. 5 depicts a functional block diagram of the active rectifier control, in accordance with non-limiting embodiments of the present technology. The values of the measured phase currents are fed to the block (23) that implements the Park-Clarke transformation. The resulting values of the d-q components arrive at blocks (24) and (25) in which the given values are subtracted from the actual values and converted by the PID regulators (26), (27). In the block (28), the reference values for each phase are restored and control pulses are fed to the active rectifier in the block (29) based on these values.

At the moment when the vector control switches on (the generator rotates at no-load speed), the values of the phase voltages U_{A} and U_{B} are identified according to the voltage sensors VS_{A} and VS_{B} which are supplied to the rotor rotation angle calculation block (30). The value of the angle goes to the integrator (31) and is set as the initial value of the rotor rotation angle, on the basis of which the transformations in blocks (23) and (28) are made. When the actual value of the rotor rotation angle differs from the initial value, the mismatch to the current d-component appears, a non-zero value appears at the output of the PI-controller (32), which enters the integrator (31) and changes the value of the angle, realizing the dynamic determination of the actual rotor rotation angle. The introduction of the correction factor K1 (33) allows the compensation of the current d-component and allows to identify the position of the EMF vector.

1. A method of adjusting a wind-turbine power take-off, the method executable in a system including:
a wind turbine;
a synchronous electric generator operatively coupled to the wind turbine;
an active rectifier and a down converter for controlling voltage and current settings of the synchronous electric generator; and
a micro-controller configured to control operation of at least one of the synchronous electric generator, the active rectifier and the down converter, the micro-controller storing computer executable instructions, which instructions when executed are configured to cause the micro-controller to execute the method comprising:
obtaining a measurement of generator's output phase voltages;
determining rotor rotation angle based on the measured generator's output phase voltages;
receiving a target energy value including one of a target consumer voltage and a target consumer current;
executing an optimization algorithm to determine an optimized speed of the synchronous electric generator based on the target energy value; and
controlling the synchronous electric generator based on the optimized speed of the synchronous electric generator, the controlling being executed by at least one of:
setting an electromagnetic torque T_{E} on a shaft of the synchronous electric generator, proportional to a linear value of a current value of the synchronous electric generator, determined by the phase currents i_{A}, i_{B}, i_{C} generated by the active rectifier;
setting currents i_{A}, i_{B}, i_{C} in windings of the synchronous electric generator, the currents being in a sinusoidal form; and
controlling the active rectifier boost converter function operating in conjunction with the down converter.

2. The method of claim 1, wherein the setting the electromagnetic torque T_{E} on a shaft of the synchronous electric generator further comprises transmitting, by the microcontroller, pulse-width modulated signals to at least one of the active rectifier and the down converter.

3. The method of claim 1, wherein the method further comprises reducing the consumer voltage by controlling the down converter.

4. The method of claim 1, further comprising, measuring an actual consumer current and, based on the actual consumer current, generating and transmitting at least one of a second pulse-width modulated signal to a ballast and a third pulse-width modulated signal to the down converter, in order to adjust the consumer current.

5. The method of claim 1, wherein the method further comprises:
in response to the wind speed being higher than the calculated wind speed, setting the electromagnetic torque T_{E} on a shaft of the synchronous electric generator that exceeds the torque T_{R} of the shaft of the synchronous electric generator to reduce the speed of the wind turbine.

6. The method of claim 5, wherein the method further comprises:
in response to determining that a voltage on a capacitor, located between the active rectifier and the down converter, exceeds a threshold capacitor voltage, generating and transmitting a second pulse-width modulated signal to the ballast; and adjusting a current between the active rectifier and the down converter.

7. The method of claim 5, wherein the method further comprises:
Generating and transmitting a breaking signal S1 to a breaking system to cause a stepped stop of the synchronous electric generator in response to the output voltage of the active rectifier exceeding a threshold voltage.

8. The method of claim 1, wherein the optimization algorithm to determine an optimized speed of the synchronous electric generator based on the target energy value comprises:
based on the measured phase currents generated by a synchronous electrical generator, estimating change in an output energy of the synchronous electric generator during a time interval;
based on the change in the output energy and a corresponding change in the rotation speed during the time interval, determining an optimized speed of the synchronous electric generator.

9. The method of claim 1, wherein the rotor rotation angle is determined based on the phase currents measured by current sensors located between the synchronous electric generator and the active rectifier.

10. A system for adjusting wind turbine power take-off, the wind turbine being operatively coupled to a synchronous electric generator, the system comprising:
a plurality of phase current sensors operatively connected to the synchronous electric generator, the phase current sensors being configured to determine phase currents at the output of the synchronous electric generator;
a plurality of voltage sensors operatively connected to the synchronous electric generator and configured to determine phase voltages at the output of the generator;
an active rectifier being configured to generate an electromagnetic torque by forming sinusoidal in-phase currents in the phase windings of the synchronous electric generator; and
a microprocessor, operatively connected to the synchronous electric generator, the active rectifier and a down converter being configured to control operation of at least one of the synchronous electric generator, the active rectifier and the down converter, based on the phase currents and the rotor rotation angle determined from the phase voltages.

11. The system of claim 10 further comprising a breaking system operatively connected to the windings of the synchronous electric generator and configured to produce a stepped breaking of the synchronous electric generator or an emergency stop of the wind turbine in response to a breaking signal received from the microprocessor.

12. The system of claim 10, further comprising a ballast with pulse-width modulated switching, the ballast being configured, under control of the microcontroller, to divert electric power in response to the voltage at the output of the active rectifier exceeding a predetermined value.

13. The system of claim 10, wherein the down converter is configured to maintain voltage in a DC link between the active rectifier and the down converter within a predetermined range and to reduce voltage at the output of the power take-off system to match the target consumer voltage.

14. The system of claim 10, further comprising current sensors located at the input and output of the down converter, the current sensors configured to transmit the measured current to the microprocessor.

15. The system of claim 10, wherein the synchronous electric generator is a disk structure with permanent magnets with axial magnetization, the rotor comprising two coaxial discs arranged on both sides of the stator and rigidly interconnected.

16. The system of claim 10, further comprising a power supply unit for electronic devices connected directly to the output of the synchronous electric generator.

17. A method of adjusting wind turbine power take-off, based on controlling a speed of a wind turbine in accordance with an optimum speed search algorithm that estimates a change in an output energy for a given time interval as the rotational speed changes and sets a new speed value based on the values obtained;
at the wind speed above a calculated wind speed, which corresponds to the nominal value of power, ensuring stabilization of the electromagnetic torque on the synchronous winding shaft, at the same time the control of the speed of rotation in the entire range of working wind speeds is carried out by a power take-off system consisting of:
a synchronous generator with permanent magnets with a rotor position sensor mounted on a single shaft with a wind turbine;
a power supply unit for electronic devices connected directly to the output of an electrical machine;
an active rectifier with phase current sensors CS_{A}, CS_{B}, CS_{C}, phase voltage sensors VS_{A}, VS_{B}, connected at the input, and a voltage sensor VS, a capacitor C₀, a current sensor CS1, all three connected at the output, while the active rectifier is made with a vector control, implemented by a microprocessor programmable controller, providing the possibility of specifying the electromagnetic torque by forming sinusoidal, in-phase with EMF, currents of a given amplitude in the phase windings of the generator and converting them at the output of the active rectifier to the charging current of the DC link capacitor with a voltage higher than the consumer specified output voltage, this stabilization of the voltage in a predetermined range of values is provided by a down converter under control of the microprocessor controller at full power take-off by the consumer, and, if the full power take-off is impossible by consumer, the stabilization of the voltage is provided by a down converter and a ballast controlled by the microprocessor controller;
the down converter, being controlled by the microprocessor controller, the down converter being configured to maintain voltage in a DC link between the active rectifier and the down converter within a predetermined range of values, as well as to lower the output voltage to the desired level of consumer and to limit a maximum current value for a short circuit protection;
a ballast for removal of excess electricity under control of a microprocessor controller;
a braking system associated with the windings of the synchronous electric generator, which, under the control of the microprocessor controller, produces a stepped braking of the synchronous electric generator or an emergency stop of the wind turbine,
at the moment when the vector control is turned on and the generator rotates at no-load speed according to the voltage sensors VS_{A} and VS_{B}, the phase voltage values U_{A} and U_{B} are determined, which are fed to the rotor rotation angle calculation block, the angle value is fed to the integrator and is set as the initial value of the rotor rotation angle, based on which transformations in blocks are produced, with the actual value of the rotor rotation angle different from the initial one, there is a mismatch in the current d-component, at the output of the PI-controller the value other than zero is obtained, which is supplied to an integrator, changes the value of the angle, implements dynamic determination of the actual rotor rotation angle, the position of the EMF vector is determined and the compensation for the current d-component is introduced.

18. The method of claim 17, wherein the power take-off system further comprises a ballast with pulse-width modulated switching.

19. The method of 17, wherein the synchronous electric generator is a disk structure with permanent magnets with axial magnetization, the rotor consisting of two coaxial discs arranged on both sides of the stator and rigidly interconnected.
